(19) United States
(12) Patent Application Publication
(10) Pub. No.: US 2007/0137832 A1
(43) Pub. Date: Jun. 21, 2007

(54) Component for a device for air-conditioning the inside of a vehicle and device for air-conditioning the inside of a vehicle

(75) Inventors: Walter Wolf, Oppenweiler-Zell (DE); Thomas Feith, Korntal-Munchingen (DE); Jochen Schmitz, Leonberg (DE)

Correspondence Address: FOLEY AND LARDNER LLP;SUITE 500, 3000 K STREET NW, WASHINGTON, DC, 20007, US

(73) Assignee: BEHR GMBH & CO. KG, D-70469 STUTTGART (DE)

(21) Appl. No.: 10/574,794

(22) PCT Filed: Oct. 8, 2004
(86) PCT No.: PCT/EP04/11277

§ 371 Date: Aug. 16, 2006

(30) Foreign Application Priority Data
Oct. 8, 2003 (DE) 103 47 230.4
Mar. 2, 2004 (DE) 10 2004 010 616.9

(51) Int. Cl. B60H 3/00

(52) U.S. Cl. 165/42

(57) ABSTRACT

The invention relates to a component (4), especially a hybrid component, for a device (1) for air-conditioning the inside of a vehicle. Said component comprises a metal base body (6) which is at least partially covered with plastic (K), whereby the cavity thereof forms a flow channel (8) for a cross-flow medium; also comprising at least one flow control device (12) which controls the amount of flow of the medium which is integrated into said flow channel. The invention also relates to a device (1) for air-conditioning the inside of a vehicle by means of an air-conditioning system (2) and a component (4) connected to the air-conditioning system (2).

The invention relates to a component, in particular a hybrid component, for a member of a vehicle, which is used as a flow duct for a device for air-conditioning the inside of a vehicle. Furthermore, the invention relates to a device for air-conditioning the inside of a vehicle with a component of this type and an air-conditioning system.

Members formed from tubes, for example cross members, which are composed of metal and have correspondingly large wall thicknesses are known from motor vehicle engineering. In this case, the wall thicknesses are of suitably thick design for sufficient dimensional, flexural, buckling and torsional stability and for sufficient load-bearing capacity under pressure. The cross member, which is designed as a tubular or hollow profile, is suitable in principle for conducting air, for example from an air-conditioning system arranged centrally in the front region of the vehicle and the air conduction means to lateral discharge vents.

A cross member of this type is known, for example, from DE 100 64 522 A1. The cross member here is formed, for the purpose of reducing the weight, from a lightweight construction material, in particular from a light metal, in the manner of a shell-type component or basic body in which a plastic core forming at least one duct is arranged to give the cross member sufficient rigidity and load-bearing capacity under pressure. For the air flow to exit, the duct is provided with a plurality of openings for tapping off air.

To distribute the air to be conducted from the air-conditioning system into the inside of the vehicle via the air conduction means, a ventilation flap is usually provided in a mixing chamber arranged between the air-conditioning system and the air conduction means and controls the air flowing from the air-conditioning system into the air conduction means with regard to rate, distribution, shutting off and/or deflection. In addition, flaps for setting the rate of air flowing into the inside of the vehicle are provided at the air tap-off points leading directly into the inside of the vehicle. Such an arrangement of the ventilation flap in the mixing chamber requires a large amount of construction space.

The invention is therefore based on the object of indicating a component which can be used as an air conduction means for air-conditioning the inside of a vehicle and has a particularly simple construction saving construction space. Furthermore, a particularly simple device for air-conditioning the inside of a vehicle with a component of this type is to be indicated.

In the case of a component, the object is achieved according to the invention by the features of independent claim 1. The object with regard to the device for air-conditioning the inside of a vehicle is achieved by the features of independent claim 13.

Advantageous developments of the invention are the subject matter of the subclaims.

The invention is based on the consideration that because of the spatial arrangement of the air-conditioning system, the mixing chamber and the air conduction duct, which is connected thereto, along the longitudinal axis (also called X-axis) of the vehicle, the construction space of the mixing chamber is limited and, because of the arrangement of the ventilation flap in the mixing chamber, an excessive amount of construction space is required and this is to be reduced. Use is therefore to be made in a particularly simple manner of construction space which is present in any case. For this purpose, it is provided, in the case of a component which comprises a metallic basic body which is at least partially lined with plastic and the cavity of which forms a flow duct for a medium flowing through it, to use the cavity of the basic body for the integration of a flow control device for controlling the flow rate of the medium. The flow control device is used in particular for controlling an air flow which is guided from an air-conditioning system of a vehicle into the inside of a vehicle and is provided for controlling the temperature of the inside of the vehicle. With the aid of the flow control device, the air flow or the flow rate of the air flow through the flow duct can be completely closed or opened or can be brought into any desired intermediate position. That is to say, the flow rate can be set to zero or the flow duct is opened to maximum extent for the air flow, i.e. the flow rate of the air flow through the flow duct is set to a maximum. The air flow can also be deflected.

A flow control device of this type arranged directly in the flow duct instead of the mixing chamber utilizes construction space which is already used, so that, by shifting the arrangement of the flow control device from the mixing chamber into the flow duct, the construction space of the mixing chamber can be reduced or the mixing space of the air-conditioning system is enlarged.

The metallic basic body is expediently provided with a plurality of flow openings for the entry and/or exit of the medium, for example fresh air, cold air and/or hot air, said openings being arranged laterally, centrally, at the top and/or bottom. In this case, the lateral flow openings serve to ventilate the side windows and the lateral inside of the vehicle. The central flow opening, which can be divided, serves to ventilate the front region. The flow openings which are directed upward and/or downward serve to ventilate the footwell and/or the windshield. Depending on the setting of an air-conditioning system connected to the component, individual flow openings can be completely closed and/or opened or can be partially closed and/or opened.

For an arrangement of the flow device that saves as much construction space as possible, said flow device is preferably arranged in a transition region between two flow openings. In a possible embodiment of the component, the flow control device is preferably arranged between a central flow opening and a lateral flow opening.

The basic body which is partially lined with plastic may advantageously be designed such that it is perforated at least in some regions. This expediently takes place, for example, in an opening region. A basic body of this type has, in particular, the advantage of saving weight and/or reinforcing the structure.

For a flow through of air or distribution of air that controls both flow openings, the axis of rotation of the flow control device expediently runs perpendicularly to the flow opening. In this connection, the arrangement of the axis of rotation in the flow duct depends substantially on the distribution of air between the one and the other flow opening. As an alternative, the axis of rotation of the flow control device can run horizontally to the flow opening. In this exemplary embodiment, the axis of rotation is preferably mounted centrally and arranged transversely to the flow opening.

The flow control device is designed as a control flap, in particular as a rocker flap, a roller flap or a butterfly flap. As an alternative, the flow control device can be designed as a rolling tape cassette, a louver cassette, a V flap, or a double flap, for example a barn door flap.

In order to prevent a return flow of the medium, in particular of air of the air-conditioning system, back into said air-conditioning system, the flow control device is assigned at least one partition. With the flow control device open in the direction of the flow duct, the partition is used to prevent the air from flowing back into the air-conditioning system, in particular into the mixing chamber.

Depending on the type and function and arrangement of the flow control device, in particular the control flap, said flow control device can comprise, for example, at least two deflection elements arranged about an axis of rotation, one of the deflection elements being arranged displaceably between a first position completely closing the central flow opening and a second position completely opening the central flow opening, and the other deflection element being arranged displaceably between a third position completely closing the lateral flow opening and a fourth position completely opening the lateral flow opening. With such an arrangement of the flow control device, in addition to an arrangement saving as much construction space as possible a construction saving components, in particular flow control elements, is also provided.

For as flexible as possible a setting of the distribution of air, for example into the lateral flow duct or forward into the front region, the deflection elements are arranged displaceably separately from each other. As an alternative, the deflection elements can be coupled and therefore displaced as a function of each other. In a preferred embodiment, the deflection elements can be moved symmetrically and/or asymmetrically relative to each other. For example, the deflection elements, for example flaps or wings, are arranged such that they can be moved about the axis of rotation symmetrically, i.e. jointly at a constant opening angle from each other. As an alternative, the deflection elements can be arranged separately from each other in a manner such that they can be moved into any desired position with respect to each other at an opening angle which can be set as desired.

For a construction of the component which is as simple as possible and an installation which is as simple as possible, the flow control device is designed as a separate, premanufactured module. This makes it possible for a flow control device to be integrated retrospectively into an already existing vehicle, in a component, in particular hybrid component, which is designed as a flow duct, as a result of which the flap in the mixing chamber can be omitted and a larger mixing space is provided.

In the case of the device for air-conditioning the inside of a vehicle with an air-conditioning system and a component connected to the air-conditioning system, the component comprises a metallic basic body which is at least partially lined with plastic and the cavity of which forms a flow duct for a medium flowing through it, in particular air, and in which at least one flow control device for controlling the flow rate of the medium is integrated. In this case, the flow control device is arranged, for example, in the component in the region in which it is connected to the air-conditioning system. In other words: the flow control device is arranged in the transition region from the air-conditioning system to the flow duct in the component itself.

The basic body which is partially lined with plastic can advantageously be designed such that it is perforated at least in some regions. This expediently takes place, for example, in an opening region. A basic body of this type has, in particular, the advantage of saving weight and/or reinforcing the structure.

In general, the component which is designed as a flow duct is arranged centrally on the air-conditioning system, the flow duct running in each case toward the side and being provided with a plurality of openings for the entry and/or exit of the medium. The flow control device is preferably arranged in a transition region between two flow openings, for example between a central opening, in particular a central nozzle, and a side opening, in particular a side nozzle, of the flow duct.

The advantages obtained with the invention reside in particular in the fact that, in the case of a hybrid component which is designed as a flow duct and in which a flow control device is integrated, and in the case of use in an air-conditioning system of a vehicle, an embodiment, which is particularly compact and saves construction space, of a device for air-conditioning the inside of a vehicle is made possible. Such a compact and space-saving embodiment also means that the weight is correspondingly low. Such a component with an integrated flow control device also makes use again of construction space which is already used; the component is therefore particularly suitable for use as an air conduction duct for an air-conditioning system in a vehicle.

Exemplary embodiments of the invention are explained in more detail with reference to a drawing, in which:

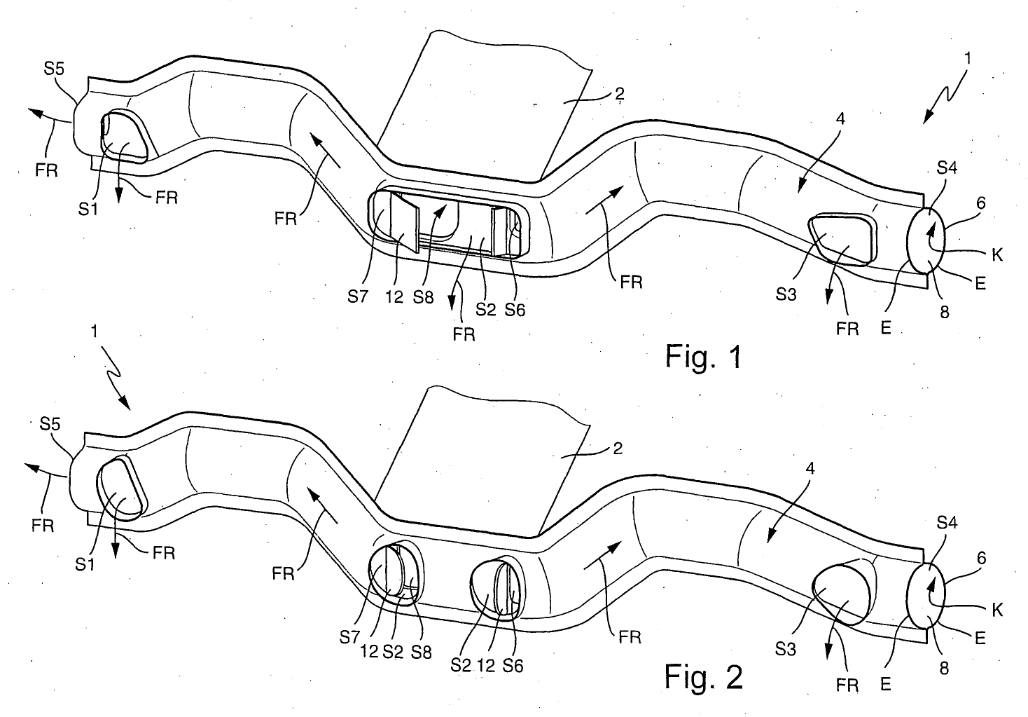

FIG. 1 shows, diagrammatically, a perspective illustration of an air-conditioning device with an air-conditioning system and with a component which is connected to the air-conditioning system and is designed as a flow duct,

FIG. 2 shows, diagrammatically, an alternative embodiment of an air-conditioning device with an alternative embodiment for the component,

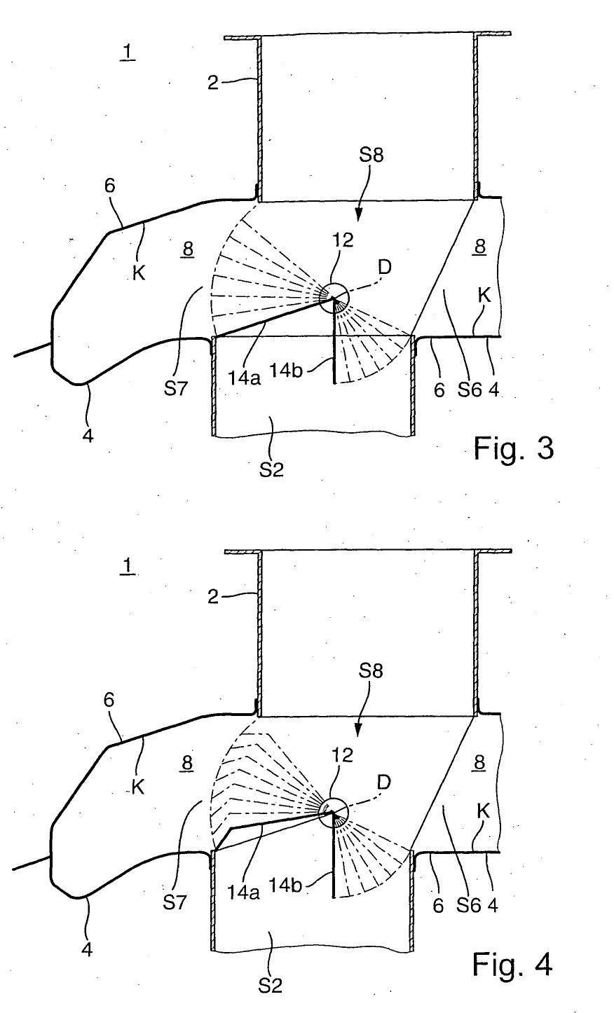

FIGS. 3 to 5 show, diagrammatically, a cross section through a device in the region in which air-conditioning device and component are connected, together with various embodiments of a flow control device arranged in the connecting region, and

FIGS. 6 to 13 show, diagrammatically, a cross section through the component in a flow opening region, together with various embodiments of a flow control device arranged in the flow opening region.

Mutually corresponding parts are provided with the same designations in all of the figures.

FIG. 1 shows, diagrammatically, a device 1 for air-conditioning the inside of a vehicle. The device 1 is installed, for example, in a vehicle and regulates an air flow conducted from an air-conditioning system 2 into the inside of the vehicle. For this purpose, the device 1 comprises the air-conditioning system 2 to which a component 4, which is designed as a flow duct, is connected.

The component 4 has a basic body 6 which is preferably formed from sheet metal, in particular from a light sheet metal, for example from aluminum sheet, magnesium sheet or refined steel sheet. The basic body 6, for example formed from two elements E lying one on the other, is designed in the exemplary embodiment in the closed state as a hollow profile, in particular as a tubular hollow profile. As an alternative, the basic body 6 may also be designed as a hollow profile with a box-like cross section and/or may be designed such that it is perforated at least in some regions. In a possible embodiment with a box-shaped cross section, the basic body 6 is formed from two elements E, for example a U profile or a lower shell and a cover.

The basic body 6 is provided on the inside with plastic K. In this case, the plastic K can be attached, fitted or injection-molded on in the manner of a plastic lining. The basic body 6 which is at least partially lined with the plastic K serves in the closed state as a flow duct 8, in particular as a flow duct for conducting a medium, for example air, of the air-conditioning system 2.

The air-conditioning system 2 generally comprises, in a manner not illustrated specifically, a fan for supplying fresh air, a filter for cleaning air, an evaporator as part of a cooling circuit, a heating body as part of a heating circuit, a temperature-control device and a mixing device for controlling the temperature of the air which is to be supplied to the inside of the vehicle and is conducted in the flow duct 8 of the component 4.

For the air-conditioning of the inside of the vehicle, the component 4 is provided with a plurality of flow openings S1 to S8 of which the flow openings S1 to S5 open laterally, centrally and/or forward into the inside of the vehicle. As an alternative or in addition, further flow openings (not illustrated specifically) can open upward and/or downward, in particular into the windshield region or the footwell of the inside of the vehicle.

The flow opening S8 serves to supply the air which has been air-conditioned by the air-conditioning system 2 into the flow duct 8, the air being conducted along a flow direction FR by means of the flow duct 8 via the lateral flow openings S6 and S7 thereof to the flow openings S1 to S5 opening into the inside of the vehicle.

As is illustrated according to FIG. 1, the component 4 is arranged centrally on the air-conditioning system 2. That is to say, the component 4 has a curved profile for accommodating the air-conditioning system 2, the air-conditioning system 2 being connected in the centrally arranged curvature, so that the flow duct 8 has flow arms which run laterally and open into lateral flow openings S5 and S4, in particular side nozzles, for example for ventilating the side windows.

To enlarge the mixing space in the mixing device or mixing chamber for air which is temperature-controlled as well as possible, it is provided that the air-distributing flap which is usually arranged there is omitted. For an arrangement, which saves as much construction space as possible, of a flow control device 12 bringing about the distribution of air, said flow control device is arranged in a transition region between two flow openings S1 to S7, for example between the lateral flow opening S7 and the central flow opening S2. In other words, the flow control device 12 is integrated, in particular in the region in which the component 4 is connected to the air-conditioning system 2, between the relevant flow openings S2, S7 and S8 in the flow duct 8. The construction space which is available in any case in the component 4 is therefore used as movement space for controlling the distribution of air. By this means, a simple shifting of the conventional ventilation flap of the mixing chamber into the region in which the air-conditioning system 2 and component 4 are connected is made possible by flow duct 8.

FIG. 2 shows, diagrammatically, an alternative embodiment of an air-conditioning device 1 of an alternative embodiment for the component 4. Instead of a large central flow opening S2 for the front region of the inside of the vehicle, two central flow openings S2 are provided in each of which is arranged a flow control device 12 for distributing air for the flow duct 8 into the side arms thereof. The respective flow control device 12 is arranged in each case in the transition region of the relevant flow openings S2 and S7 or S2 and S6, thus bringing about a distribution of air into the lateral arms of the flow duct 8 along the flow direction FR.

FIGS. 3 to 5 show, diagrammatically, a cross section through a device 1 in the region in which the air-conditioning system 2 and component 4 are connected, together with various embodiments of a flow control device 12 arranged in the connecting region.

FIG. 3 shows a flow control device 12 which is integrated in the flow duct 8, is designed as a “V flap” and by means of which the flow rate of the air in the direction of the flow opening S7 and S2 is controlled. Depending on the type and design of the flow duct 8, the latter may be of polygonal, in particular square or circular, design in cross section.

The flow control device 12 comprises an axis of rotation D about which two deflection elements 14a and 14b are pivotably arranged. In this case, the axis of rotation D of the flow control device 12 runs perpendicularly to the flow opening S7 or S2 and to the flow direction FR. The axis of rotation D is largely arranged centrally in the flow duct 8 in a transition region between the two flow openings S7 and S2.

The deflection elements 14a, 14b each have a surface which essentially corresponds to the cross-sectional area of the associated flow opening S7 or S2. FIG. 3 illustrates various opening and closing states of the deflection elements 14a, 14b for the partial or complete opening or closing of the relevant flow opening S7 or S2.

FIG. 4 shows an alternative shape of the flow control device 12 with an alternative shape of the deflection element 14a which has a slightly bent shape. The construction, the arrangement and the shape of the flow control device 12 is essentially determined by the predetermined distribution of air in the relevant region of the flow duct 8. For example, the respective deflection element 14a and/or 14b may be designed with a spoiler or other form of flap.

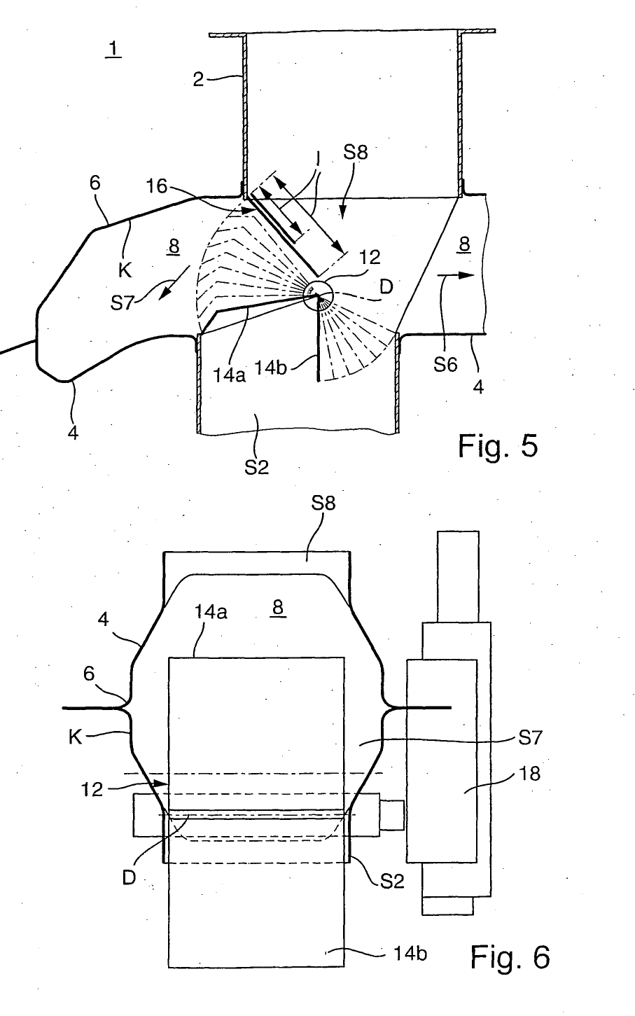

FIG. 5 shows the flow control device 12 according to FIG. 4 with an associated partition 16 which prevents the air from flowing back into the flow opening S8 and therefore in the direction of the air-conditioning system 2. In this case, the partition 16 may be a stationary or moveable design. The length l of the partition 16 is limited by a bearing belonging to the flow control device 12. FIG. 5 illustrates two partitions 16 of different length. The partition 16 may alternatively also be designed as an individual flap.

FIG. 6 to 13 show, diagrammatically, a cross section through the component 4 in the transition region between two of the flow openings S1 to S8, together with various embodiments of a flow control device 12 arranged there.

FIG. 6 shows a flow control device 12, the axis of rotation D of which runs horizontally to the relevant flow opening S2. The flow control device 12 has flap-like deflection elements 14a, 14b for opening and/or closing the flow openings S7 and S2, respectively. The position of the deflection elements 14a, 14b is set via a drive unit 18.

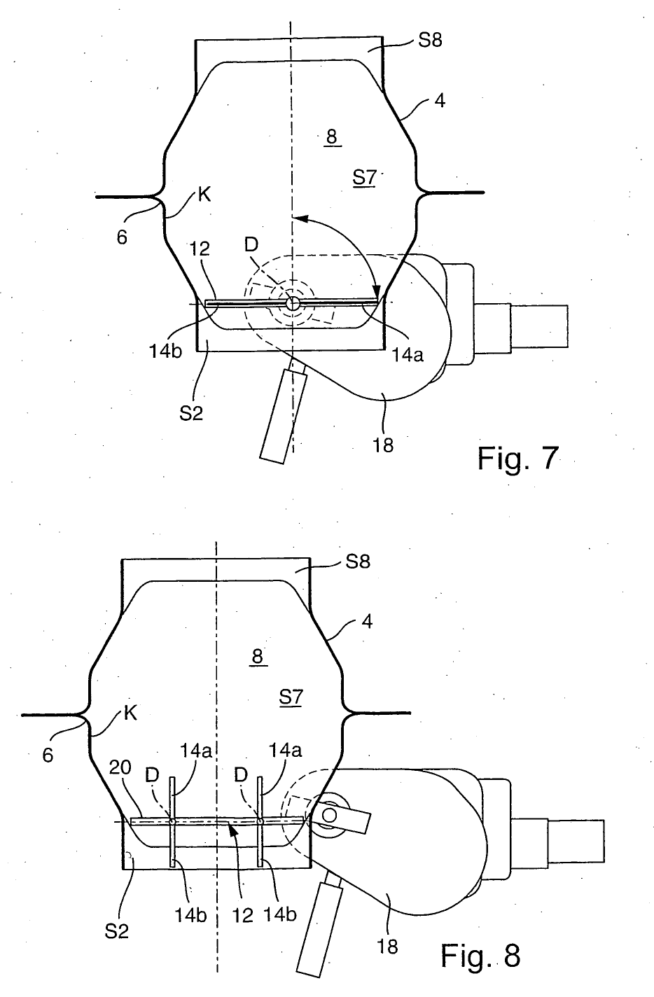

FIG. 7 shows a further embodiment of a flow control device 12 for controlling the flow rate of a fluid medium, in particular air, through the flow duct 8 in the direction of the flow openings S7 and S2. The deflection elements 14a, 14b are mounted centrally and can be moved by means of the drive unit 18 between a position completely closing the relevant flow opening S7 or S2 and a completely open position.

FIG. 8 shows a further embodiment of a flow control device 12 which is designed as a double flap or louver. For the displacement of the deflection elements 14a, 14b, the two flaps of the double flap are driven by the drive unit 18 via a common drive spindle 20.

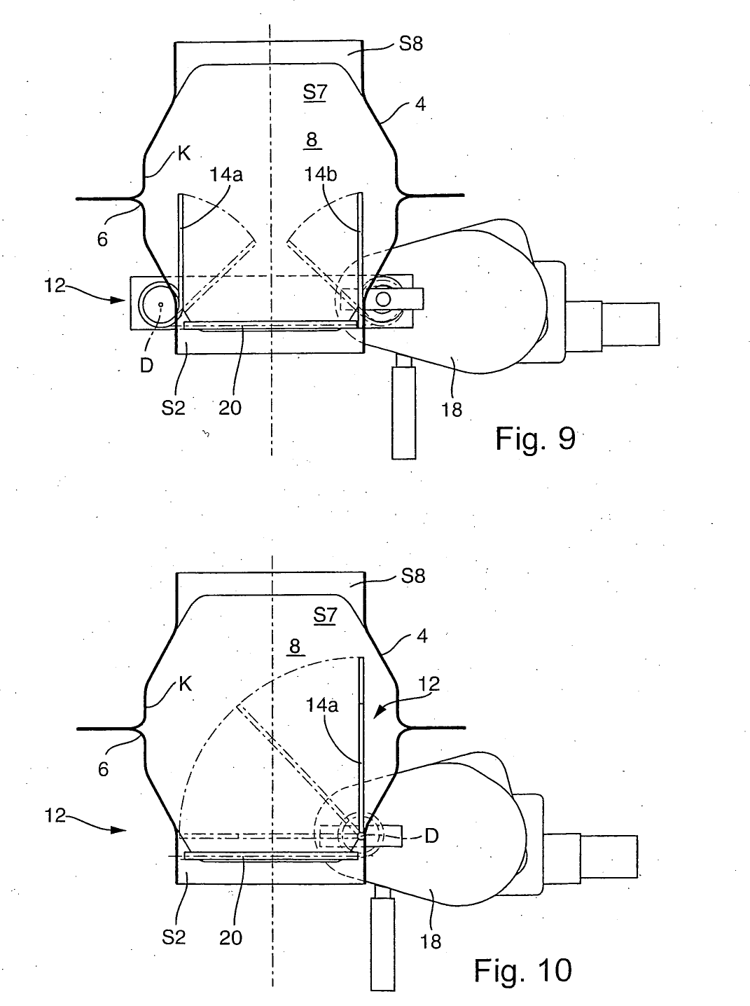

FIG. 9 shows, as flow control device 12, a barn door flap which is formed from two flaps and is likewise connected to the drive unit 18 via a common drive spindle 20.

FIG. 10 shows, as flow control device 12, a one-sided flap which is likewise connected to the drive unit 18.

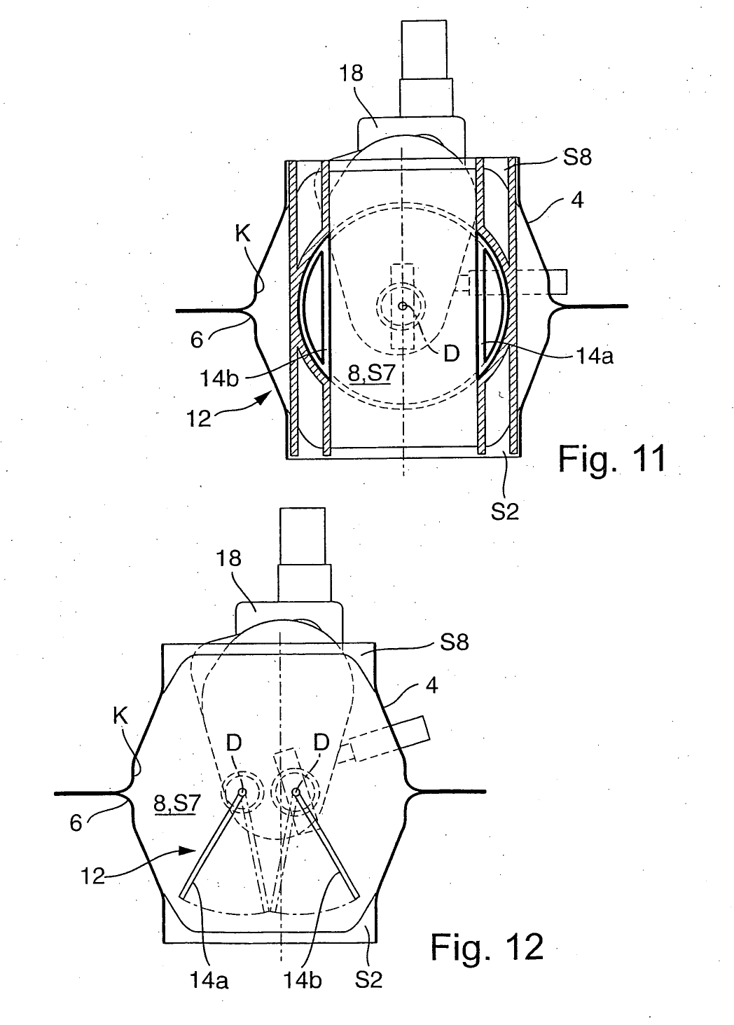

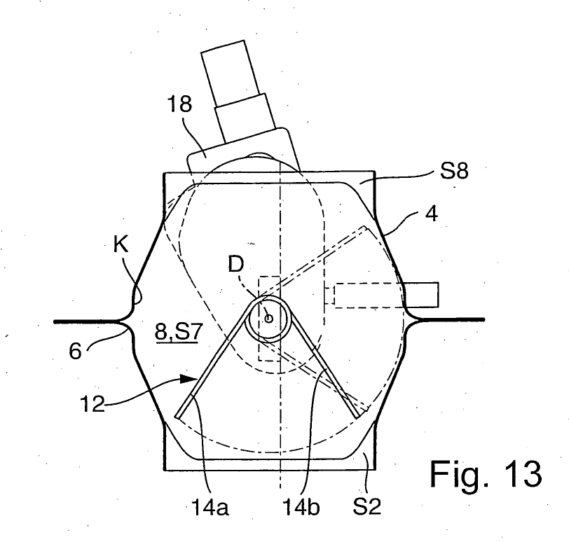

FIG. 11 shows a further embodiment of a flow control device 12—a “roller flap” which is arranged centrally in the flow duct 8 and the flap or deflection elements 14a, 14b of which are changed in their position via a roller. FIGS. 12 and 13 show further alternative embodiments of a flow control device 12, firstly a butterfly flap and secondly a rocker flap.

All of the flow control devices 12 described here can be premanufactured as a separate module which can be integrated in a particularly simple manner, even retrospectively, in the component 4.

Depending on the type and shape and design of the flow control device 12, the deflection elements 14a, 14b can be activated or can be moved in a coupled manner or separately from each other. The deflection elements 14a, 14b can also be moved symmetrically and/or asymmetrically relative to each other.

By means of a corresponding position of the deflection elements 14a, 14b, the flow control device 12 at least partially or completely closes or opens the flow duct 8 into the relevant flow opening S1 to S8.

### LIST OF DESIGNATIONS

1 Air-conditioning device
2 Air-conditioning system
4 Component
6 Basic body
8 Flow duct
12 Flow control device
14a, 14b Deflection elements
16 Partition
18 Drive unit
20 Drive spindle
D Axis of rotation
E Elements
FR Flow direction
K Plastic
S1 to S8 Flow openings

1. A component, in particular hybrid component, for a device for air-conditioning the inside of a vehicle, comprising a metallic basic body which is at least partially lined with plastic and the cavity of which forms a flow duct for a medium flowing through it and in which at least one flow control device for controlling the flow rate of the medium is integrated.

2. The component as claimed in claim 1, in which the metallic basic body is provided with a plurality of flow openings for the entry and/or exit of the medium, said flow openings being arranged laterally, centrally, at the top and/or bottom.

3. The component as claimed in claim 1, in which the flow device is arranged in a transition region between two flow openings.

4. The component as claimed in claim 3, in which the flow control device is arranged between a central flow opening and a lateral flow opening.

5. The component as claimed in claim 1, in which the axis of rotation of the flow control device runs perpendicularly to the flow opening.

6. The component as claimed in claim 1, in which the axis of rotation of the flow control device runs horizontally to the flow opening.

7. The component as claimed in claim 1, in which the flow control device is designed as a control flap, in particular as a rocker flap, a roller flap or a butterfly flap.

8. The component as claimed in claim 1, in which the flow control device is assigned at least one partition.

9. The component as claimed in claim 1, in which the flow control device, in particular the control flap, comprises at least two deflection elements arranged about an axis of rotation, one of the deflection elements being arranged displaceably between a first position completely closing the central flow opening and a second position completely opening the central flow opening, and the other deflection element is arranged displaceably between a third position completely closing the lateral flow opening and a fourth position completely opening the lateral flow opening.

10. The component as claimed in claim 9, in which the deflection elements can be activated in a coupled manner or separately from each other.

11. The component as claimed in claim 9, the deflection elements being moveable symmetrically and/or asymmetrically relative to each other.

12. The component as claimed in claim 1, in which the flow control device is designed as a separate, premanufactured module.

13. A device for air-conditioning the inside of a vehicle with an air-conditioning system and a component connected to the air-conditioning system as claimed in claim 1, the component comprising a metallic basic body which is at least partially lined with plastic and the cavity of which forms a flow duct for a medium flowing through it, in particular air, and in which at least one flow control device for controlling the flow rate of the medium is integrated.

14. The device as claimed in claim 13, in which the flow control device is arranged in the component in the region in which it is connected to the air-conditioning system.

15. The device as claimed in claim 13, in which the component is arranged centrally on the air-conditioning system and the flow duct runs in each case toward the side and is provided with a plurality of flow openings for the entry and/or exit of the medium.

16. The device as claimed in claim 13, in which the flow control device for controlling the distribution of air is arranged between a central flow opening, in particular a central nozzle, and a lateral flow opening, in particular a side nozzle, of the flow duct.

17. The device as claimed in claim 13, in which the flow control device is designed as a control flap, in particular a butterfly flap, a rocker flap or a roller flap.

18. The device as claimed in claim 13, in which the flow control device is designed as a separate, premanufactured module.
